(19) United States
(12) Patent Application Publication
(10) Pub. No.: US 2013/0346242 A1
(43) Pub. Date: Dec. 26, 2013

(54) Color changing tag for authentication

(71) Applicant: Benjamin Maytal, Mevassret-Zion (IL)

(72) Inventor: Benjamin Maytal, Mevassret-Zion (IL)

(21) Appl. No.: 13/922,412

(22) Filed: Jun. 20, 2013

Related U.S. Application Data
(60) Provisional application No. 61/661,823, filed on Jun. 20, 2012.

(51) Int. Cl. G06Q 30/06

(52) U.S. Cl. CPC G06Q 30/0609; G06Q 30/0623
USPC 705/26.35; 705/26.61; 235/491

(57) ABSTRACT

Product counterfeiting is a major problem. It is estimated that about 10% of all goods sold are counterfeits!. In recent years counterfeiters have improved significantly the quality of their products as a good counterfeit can be sold at a much higher value than a poor one. It is very difficult for untrained, regular customers to tell the difference. Currently, there are no reliable means for a person to authenticate a product.

Also, online purchases are very popular. The major mean for authentication are passwords—but they are ways to get the passwords of people to break in. Also, biometrics ID means like fingerprinting can be copied and faked.

The present invention will propose a color changing tag which can be used for authentication for both purposes

This non provisional patent application claims benefit of the filing date of provisional Application 61661823 filed on Jun. 20, 2012 as a priority date for this application.

### PRIOR ART

2D barcodes are ubiquitous and very easy to make and read. A unique product ID could be printed using 2D barcodes, however, it is also very easy to copy—a barcode can be copied in a minute and a counterfeiter can put his products in the store copying the code of existing products.

An NFC with a code could also be used to identify a product. The problem is that only a small minority of phones has NFC readers. Also, a low cost NFC code is very easy to use and reproduce.

Because of the reasons explained above there is no easy way for a user to authenticate a product in the store and no easy way for a service provider to guarantee that the online payer is really the person they have in their data base.

### SUMMARY

Color changing tags can be built using electrochromic material. This material will change it's color upon having a voltage on it. A tag can be divided to several sections each section will change it's color at a different time.

A counterfeiter which will take a picture of the tag and try to reproduce it, however, his copied tag will look differently than the original tag since the original tag has changed its color scheme.

### BRIEF DESCRIPTION OF THE DRAWINGS

FIG. 1 is a description of an elecctochromic tag.

FIG. 2 is a description of an authentication system using the above tag.

### DETAILED DESCRIPTION

The present invention will describe a color changing tag for authentication tag where different portions of the tag will change color over time and the mobile phone will report the color 2D information to an authentication server.

If a tag has a certain dimension, e.g. 2*2 Cm, and it is divided to many sections, still allowing good picture taking, with a minimal size (e.g. 2 mm), ther can be 100 such section, a mobile phone will be able to take a picture and report the color of each section and report it to a center. If the color is changing over time and the data base is keeping track of itt will be able to tell if this is an authentic tag.

It is proposed to use electrochromic material. An electrochromi material will darken it's color upon sensing a certain minimal voltage (e.g. 1.5V). For the color change it will draw a certain charge. This process is reversible.

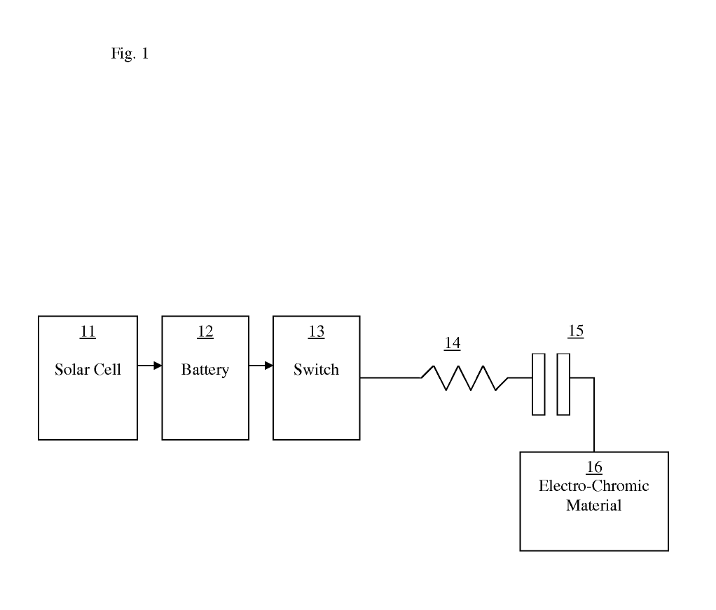

FIG. 1 is describing a single section system on a tag. An electrochromi materil 16 will be spread over the section (e.g. 2 mm*2 mm). Any color is possible—but they will be pale. It is possible that certain sections will just have the same colors but with NO electrochromic material.

It is proposed to use solar cell 11 which will charge battery 12, but a battery without a solar cell can be used. Switch 13 will connect the battery to the RC circuitry, as the switch will be closed only when the product is ready for the store, it could have been stored for 6 months—the color changing process will start from this point on. Resistor 14 and capacitor 15 values will be selected for a certain time period for the voltage to reach the required value—this can be 2 weeks, 2 months, 6 months. Once the voltage level has been reached and the capacitor is charged for the right value the electrochromic material will darken. Potentially a small battery will be put after the capacitor to allow for better charge drawing.

Each section will have different values for resistors and capacitors and hence will have it's color darkened at a different time. There will of course be a variety of colors.

Each tag will look differently than the other, and each tag will have a certain section change it's color at a predetermined time.

If a counterfeiter will take a picture of the tag he will not know how this tag will change over time—so his coped tag will look differently than the original when it hits the store. Even if he knows that lectrochromic masterial is being used he will not know the timing and even not know whet sections have an electrochromi material and change color and what not.

An alternative way is to use a simple MCU which at a give time can drive its IO lines differently and cause a color change. This will allow a bidirectional color change and allow frequent color changes—but the cost will be of course higher.

Another method for a color changing tag is to use solvent cells separated by membranes. Solvent material can be picked such that when two solvents are being put together they will change colors. This can be a chemical reaction or just a concentration dependent—red and yellow water when mixed together will turn orange over time. Several pairs of solvent cells like this can be put over the tag. Membranes at different thickness will be used per such pair. The thickness of the membrane determines the diffusion speed, and hence the color changing speed. The color change here will be gradual.

In either of the methods described above, certain sections of the tag will change their colors over time and the tag color picture will change over time.

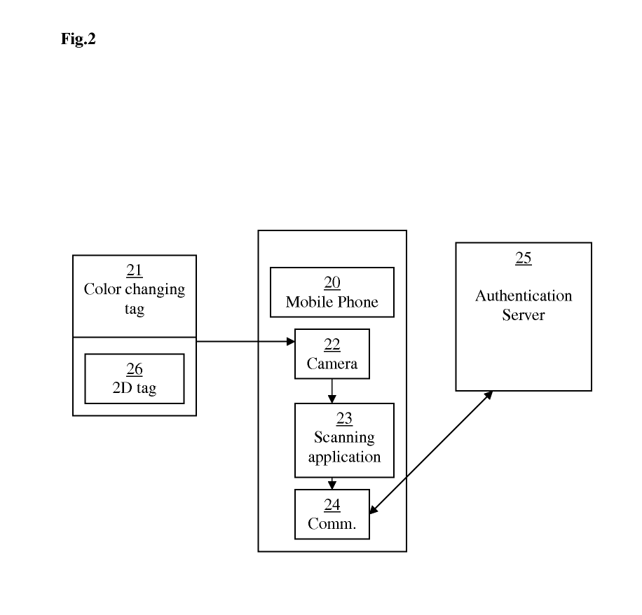

FIG. 2 described an authentication system.

Each tag will have two portions—a color changing portion 21 and a regular 2D barcode portion 26. Potentially they can be put one over the other,

A user will hold his mobile phone 20 and will activate color scanning application.

The camera will take a picture of the tag and the tag scanning program will get both the QR code from the regular tag and the color picture of the colored tag. Potentially, if it knows the tag structure, it can has a section color scheme. It will pass this information through the mobile phone communication 23 to the authentication server.

Using the QR code the program will be able to detect the specific product and using the product data base, it can know how this specific tag needs to look like at every time, and it will be able to tell is this is an authentic tag, hence an authentic product and will send an authentication message to the user.

This type of a system can also be used for a personal authentication for online purchases.

Each user will be assigned a tag as described above—with two portions, regular and colored, The user will still be asked to give his password (the tag can be stolen!). He will be asked to examine the tag as described above. Here, there will be a data base per user which will know how the user tag should look like every time and an authentication can be carried out.

What is claimed is :

1. A system where a tag can have sections of it, each change it's color over time, with a different timing per section.

2. A system as in claim one where the color changing is achieved by using an electrochromic material.

3. A system as in claim 2 where the color changing timing is achieved by using a resistor and a capacitor for voltage charging over time

4. A system as in claim 2 where the values of the resistor and capacitor can be different per section

5. A system as in claim 2 where the color changing timing is achieved by using a microcontroller, which can apply voltages per section

6. A system as in claim where pairs of solvent cells, in each pair one is separated form the other using a membrane, where the solvents are being picked such that they will change colors when put together.

7. A system as in claim 5 where the membrane can be of different thickness per cell.

8. An authentication system where a colored tag can be read and compared to a data base for verification.

9. A system according to claim 8 where a regular 2D barcode can be used as well to point the data base to a specific item.

10. A product authentication system where such a tag is attached to a product and read by a user phone and the data base is a product data base.

11. An online purchase user identification system where is user is assigned a tag which can be read by his computing devices and compared to a user data base
